(19) United States
(12) Patent Application Publication
(10) Pub. No.: US 2025/0346821 A1
(43) Pub. Date: Nov. 13, 2025

(54) PROCESS FOR PRODUCING WAXES FROM PYROLYSIS OF PLASTICS

(71) Applicant: ABUNDIA PLASTICS EUROPE LIMITED, Belfast (GB)

(72) Inventor: Martin Atkins, Belfast (GB)

(21) Appl. No.: 18/872,593

(22) PCT Filed: Jun. 8, 2023
(86) PCT No.: PCT/GB2023/051489

§ 371 Date: Dec. 6, 2024

(30) Foreign Application Priority Data
Jun. 8, 2022 (GB) 2208413.1

(51) Int. Cl. C10G 73/34; C10G 1/10; C10G 7/12; C10G 49/04

(52) U.S. Cl. CPC C10G 73/34; C10G 1/10; C10G 7/12; C10G 49/04; C10G 2300/1037; C10G 2300/4006

(57) ABSTRACT

The present invention relates to producing hydrocarbon products from a polymer feed. In particular, the present invention relates to producing waxes from a polymer feed by pyrolysis and hydrogenation of a fluid product stream from the pyrolysis.

The present invention relates to producing hydrocarbon products from a polymer feed. In particular, the present invention relates to producing waxes from a polymer feed by pyrolysis and hydrogenation of a fluid product stream from the pyrolysis.

### BACKGROUND

Plastics are one of the most commonly used materials due to their cheap price and versatility. They are often produced for single-use purposes and making up about 10% of the commercial and household waste produced.

Plastic waste poses a unique challenge as it is not bio-degradable and can persist in the environment for centuries if it is not disposed of using a suitable method. The current widely used methods to handle plastic wastes includes landfilling, incineration and recycling. Most plastic wastes end up in landfills as current recycling and incineration facility capacity is small compared to landfill capacity. This does not align with the current drive towards increased recycling and the use of environmental process.

Incineration returns some of the energy stored in the plastics in the form of heat energy that can be used to generate steam which can be used to produce electricity. One of the biggest disadvantages of the incineration process is production of carcinogenic furans and dioxins emissions. Another disadvantage of the incineration process is the form of product. Incineration produces heat, which can only be utilized in nearby regions as it loses its energy when transported through long distances.

Plastic wastes can also be recycled to produce new plastics, recovering the plastic material which can be used to produce new plastic products. However, plastic recycling requires time and labour-intensive collection as well as separation, causing the process to have a low technical and economic feasibility. Plastic separation is difficult and cross contaminations are almost always inevitable, producing recycled products that can only be used in low grade applications. Intensive washing is also required before recycling processes take place, producing further waste.

Plastic pyrolysis is one of the most promising plastic disposal methods as it recovers energy from waste plastics in gaseous, liquid and solid form while emitting minimal pollutants. Pyrolysis is the thermal decomposition of materials at elevated temperatures in the absence of oxygen. Thus, no combustion or oxidation takes place. In plastic pyrolysis, the plastic wastes are heated to elevated temperatures to degrade the wastes into combustible gases, liquid and solid products.

Pyrolysis is a tertiary recycling process that is currently considered as a superior way to recover energy from plastic wastes or to produce useful products such as energy sources and chemical feedstock. Compared to incineration, pyrolysis produces fewer toxic gases as well as having a higher energy recovery efficiency. Pyrolysis products are also much more flexible and easy to transport compared to heat energy, which is produced during incineration.

Pyrolysis is also more feasible than plastic recycling as it is not as sensitive to cross plastic contaminations, and therefore does not require an intense separating process. It is considered as a promising green technology as even its gaseous by-product has a significant calorific value that can be reused in the pyrolysis stage to decrease the energy requirement for the pyrolysis plant.

Pyrolysis of plastics has typically focused on the conditions applied during pyrolysis in order to maximise the yield of a particular desired product, such as waxes. For example, wax production from plastics has typically been directed towards vacuum pyrolysis, whereby increased proportions of waxes (e.g. C₂₀₊ hydrocarbons) can be obtained under reduced pressure such as less than 0.5 atm. However, while there are many factors that affect different product yields and the composition of products (including the operating temperature, heat rate, retention time, for example), process are typically designed to shift the distribution towards lighter products, leading to increased losses in non-condensable gas, or towards long carbon-chain waxes produced at the expense of lighter fractions. However, this can have a detrimental affect on the production of certain hydrocarbons in the distribution, such as light waxes.

Thus, it is desirable to develop new processes designed to obtain useful product streams such as light waxes more efficiently from the pyrolysis of plastics.

### SUMMARY

It has been surprisingly found that by performing controlled pyrolysis in a rotary kiln reactor and hydrogenating pyrolysis products obtained from the reactor prior to additional processing, an improved distribution of hydrocarbon products may be obtained from the pyrolysis process. In particular, the present process has been surprisingly found to result in advantageous yields of light waxes that may be efficiently separated from liquid products. In typical wax production processes by pyrolysis, the process is designed for maximising the yield of C₂₀₊ products overall, which shifts the distribution towards increased proportions of heavy waxes. However, it has been surprisingly found that by use of the present process in which the distribution of hydrocarbon products is shifted away from increased wax production as a whole, producing increased sub-C₂₀ liquid products compared to other vacuum pyrolysis processes, an advantageous wax product distribution in terms of light waxes may be achieved. For example, by counter intuitively producing less waxes in the process, improved production of valuable light waxes (for example, waxes having a melting point of less than 100° C., preferably less than 85° C.) may be achieved.

Accordingly, an aspect of the present invention provides a process for producing waxes having a melting point of less than 100° C. from a polymer feed, the process comprising:
(i) providing a polymer feed comprising at least 80 wt. % of polyolefin polymers;
(ii) melting the polymer feed to provide a molten polymer feed;
(iii) passing the molten polymer feed to a rotary kiln reactor comprising a plurality of sequential heating zones, wherein each zone of the rotary kiln is operated at a temperature of from 300° C. to 800° C. to pyrolyze the molten polymer feed and produce a fluid product stream and a solid char product;
(iv) separating the solid char product from the fluid product stream;
(v) passing a liquid fraction of the fluid product stream comprising C₅₊ hydrocarbons to a hydrogenation reactor and hydrogenating said liquid fraction to produce a hydrogenated hydrocarbon product stream;
(vi) fractionating the hydrogenated hydrocarbon product stream to produce a C₂₀₊ wax fraction having a melting point of less than 100° C.;
(vii) fractionating the C₂₀₊ wax fraction to produce two or more separate wax fractions each having a melting point of less than 100° C.

By providing pyrolysis of plastic polymers in a temperature controlled rotary kiln, and hydrogenating the effluent from the kiln, the process has been found to provide an advantageous distribution of hydrocarbon products for producing certain light waxes. In particular, it has been found that using the present process an increased yield of light waxes having a melting point less than 100° C., which can be separated to provide a number of different wax fractions all having melting points less than 100° C. In particular, the wax fraction produced can be readily separated from a lighter hydrocarbon liquid fraction (sub-C₂₀), with the wax fraction being separable into various light wax fractions without requiring the removal of heavy wax fractions from the light waxes. In this way, the increased amount of heat energy required to separate heavy wax fractions (due to high boiling points of the wax components) from the light waxes may be avoided, providing more energy efficient production of light waxes.

A further aspect of the present invention provides an apparatus for producing waxes having a melting point of less than 100° C. from a polymer feed, the apparatus comprising:
(i) means for melting a polymer feed comprising at least 80 wt. % of polyolefin polymers to provide a molten polymer feed;
(ii) a rotary kiln reactor configured to receive the molten polymer feed from part (i), the rotary kiln reactor configured to provide a plurality of sequential heating zones, wherein each zone of the rotary kiln is configured to be operated at a temperature of from 300° C. to 800° C. to pyrolyze the molten polymer feed and produce a fluid product stream and a solid char product;
(iii) means for separating the solid char product from the fluid product stream; and
(iv) a hydrogenation reactor configured to receive a liquid fraction of the fluid product stream comprising C₅₊ hydrocarbons from part (iii) and to hydrogenate said liquid fraction to produce a hydrogenated hydrocarbon product stream;
(v) means for fractionating the hydrogenated hydrocarbon product stream to produce a C₂₀₊ wax fraction having a melting point of less than 100° C.;
(vi) means for fractionating the C₂₀₊ wax fraction from (v) to produce two or more separate wax fractions each having a melting point of less than 100° C.

### Polymer Feed

The polymer feed suitably comprises at least 80 wt. % polyolefin polymers, for example at least 85 wt. % polyolefin polymers. Preferably, the polymer feed comprises at least 90 wt. % polyolefin polymers, preferably at least 95 wt. % polyolefin polymers, for example at least 99 wt. % polyolefin polymers. In some instances, the polymer feed consists essentially of polyolefin polymers, such as polyolefin polymers with only minor amounts of contaminants that do not materially affect the process or the products formed.

Preferably, the polymer feed comprises or consists essentially of waste plastic. Sources of such waste materials include bags, bottles, films, sheets, fibres, textiles, pipes and other moulded or extruded forms.

Other plastic polymers may therefore be present as no more than 20 wt. % of the polymer feed, preferably no more than 10 wt. %, more preferably no more than 5 wt. %, for example no more than 1 wt. %. Other plastic materials may include aromatic plastic polymers, for example polystyrene; halogenated plastic polymers, for example polyvinyl chloride and polytetraflouroethylene; and polyester plastic polymers, for example polyethylene terephthalate. Preferably, these other polymers are limited in the polymer feed as in some instances these polymers can lead to gum formation, disrupting operation and requiring cleaning. Halogen-containing polymers can also cause formation of haloacids during pyrolysis which can lead to corrosion problems or require additional process steps and/or equipment to neutralise or trap the acids.

As will be appreciated, the polymer feed may in some instances comprise residual contaminants that may be present in waste plastics such as soil, paper, adhesives and piments, for example from labels, or metals. Preferably, such contaminants are present in the polymer feed in an amount of less than 5 wt. %, preferably less than 1 wt. %.

In some embodiments, the process may comprise removing non-polyolefin polymers and/or non-plastic contaminants prior to providing the feed to the present process, for example using magnets to remove metals or an optical sorting process.

Preferably, the polyolefin polymers in the feed comprise or consist essentially of polyethylene and polypropylene, for example wherein the polyolefin polymers comprise at least 90 wt. % polyethylene and polypropylene, preferably at least 95 wt. % polyethylene and polypropylene, for example at least 99 wt. % polyethylene and polypropylene. The polyethylene may be any form of polyethylene but preferably comprises or consists essentially of high-density polyethylene (HDPE) and low-density polyethylene (LDPE). Thus, the polymer feed may comprise or consist essentially of high-density polyethylene (HDPE), low-density polyethylene (LDPE) and polypropylene. In some preferred embodiments, the polyolefin polymers in the feed comprise or consist essentially of polyethylene (such as LDPE and HDPE), for example at least 90 wt. % polyethylene, preferably at least 95 wt. % polyethylene, for example at least 99 wt. % polyethylene. In some preferred embodiments, the polyolefin polymers in the feed comprise at least 40 wt. % polyethylene, preferably at least 50 wt. % polyethylene.

LDPE and HDPE are both polymers of ethylene and have the formula (CH₂CH₂)ₙ. The properties of polyethylene and thus its classification as LDPE or HDPE and its applications depend on factors such as molecular weight, branching and density. LDPE preferably has a molecular weight of from 30,000 to 50,000 g/mol and a density of from 0.910 to 0.925 g/cm³. HDPE preferably has a molecular weight of from 200,000 to 500,000 g/mol and a density of from 0.941 to 0.980 g/cm³. LDPE preferably has branching on from 1 to 4% of carbon atoms, more preferably on 1 to 3% of carbon atoms, more preferably on 1.5 to 2.5% of carbon atoms. HDPE preferably has less branching than LDPE, such as on less than 2% of carbon atoms, preferably less than 1% of carbon atoms, more preferably less than 0.5% of carbon atoms, even more preferably less than 0.1% of carbon atoms. As LDPE generally has more branching than HDPE, the intermolecular forces between the chains are weaker, its tensile strength is lower, and its resilience is higher than HDPE. In contrast, HDPE is known for its high strength-to-density ratio. HDPE is commonly used in the production of many items, including plastic bags, plastic bottles, piping and containers. LDPE is commonly used in parts that require flexibility, such as snap on lids, in trays and containers, and in plastic wraps.

Polypropylene is a polymer of propylene and has the formula (CH(CH₃)CH₂)ₙ. Preferably, the density of polypropylene is between 0.895 and 0.92 g/cm³. Polypropylene may have a melting point of from 130° C. to 170° C., depending on its tacticity. In general, the properties of polypropylene may be considered to be similar to polyethylene, however the methyl group improves mechanical properties and thermal resistance. Generally, polypropylene is tough and flexible with good resistance to fatigue. Therefore, polypropylene may be used in hinges. Polypropylene may also be used in applications requiring high temperatures, such as in medical applications which require the use of an autoclave or kettles.

In addition, polyethylene and polypropylene may be copolymerised with other monomers. The monomers selected will depend on the required properties. For example, PE may be copolymerised with vinyl acetate or with an acrylate. These copolymers may be used in athletic-shoe sole foams and in packaging and sporting goods respectively. In particular, polyethylene and polypropylene maybe copolymerised. For example, a random copolymer of polypropylene with polyethylene may be used for plastic pipework.

Polyvinyl chlorides (PVCs) are polymers comprising chlorine. The main product of PVC pyrolysis is hydrochloric acid (HCl), with a low pyrolysis oil yield. The toxic and corrosive nature of HCl poses a negative impact to the environment and human health in addition to damaging process equipment. For these reasons, it is particularly preferred that PVC not be used in pyrolysis, or only be used in low amounts. Such small amounts are ideally less than 0.1 wt. % of the polymer feed, preferably less than 0.07 wt. %, more preferably less than 0.05 wt. %. Calcium oxide may be added to the plastic feed material in order to remove hydrochloric acid which may be present/formed during the process. It will be appreciated that the amount of calcium oxide used may be varied depending on the amount of polymers comprising chlorine, such as PVC, in the polymer feed. Calcium oxide may be added in an amount of from 1 wt. % to 5 wt. %, preferably 2 wt. % to 4 wt. %, more preferably 2.5 wt. % to 3.5 wt. % with respect to the plastic feed. Calcium oxide is preferably added to the polymer feed prior to pyrolysis, such as before it is fed to the kiln. For example, calcium oxide may be added to the polymer feed in a melt extruder prior to entering the kiln, such as adding the calcium oxide to a hopper providing the feed plastics to the melt extruder.

The polymer feed is suitably melted to provide a molten plastic feed for pyrolysis. The polymer feed may be processed prior to melting to change the shape and/or size of the plastic, for example by extruding, chopping and/or shredding. The plastic feed may be in the form of pellets, flakes, threads or fibres, films or may be shredded. Preferably, the plastic feed is processed to increase the surface area, which may aid melting.

Prior to pyrolysis, the polymer feed is suitably melted, for example by melting the plastic feed followed by extrusion or otherwise conveying the molten plastic for pyrolysis in the rotary kiln. For example, the melting is preferably performed in a melt extruder. Alternatively, the polymer feed may be melted at a heated inlet to the rotary kiln or in a melting zone of the kiln prior to heating zones in which pyrolysis takes place. Melting the polymer feed may comprise heating the polymer feed to a temperature of 200 to 400° C., preferably 250 to 350° C., more preferably 265 to 325° C. The melt extruder may suitably comprise a heated screw extruder, which may be heated in any suitable way, for example using electric heaters. In other embodiments, the polymer feed may be melted by microwave heating.

### Pyrolysis

Pyrolysis of the polymer feed is carried out by providing the molten polymer feed to a plurality of sequential heating zones of a rotary kiln reactor. Rotary kilns are known to the person skilled in the art and may typically comprise a substantially cylindrical (e.g. tubular) reactor that is configured to be rotated about its longitudinal axis (i.e. an axis extending through the centre of the circular cross-section of the reactor tube along its length). The rotary kiln will typically have an inlet at one end of the reactor and an outlet at the opposite end, though the exact configuration may vary. The molten polymer feed may be fed to the kiln from a melt extruder through any suitable means such as a suitable transfer pipe. The rotary kiln may be inclined to provide a height difference between its ends such that the polymer feed and intermediate pyrolysis products (i.e. pyrolysis products formed from the feed that are still present in the kiln, which may or may not undergo further cracking prior to exiting the kiln) can be moved under gravity from the inlet to the outlet whilst the kiln is rotated. The rotation of the kiln is not particularly limited, but may for example be rotated at a rate of from 0.1 to 5 rpm, for example from 0.1 to 2 rpm.

The pyrolysis may generally be performed using any suitable conditions, of which the skilled person would be aware, and is performed by heating the polymer feed in the absence of oxygen.

The pyrolysis is preferably performed under an inert atmosphere, such as nitrogen or argon, preferably nitrogen. Thus, in preferred embodiments the rotary kiln is maintained under an atmosphere of inert gas, preferably nitrogen.

As described, the rotary kiln comprises plurality of heating zones, preferably 4 or more sequential heating zones, where preferably each heating zone operated at a higher temperature than the preceding zone. Each heating zone of the rotary kiln is suitably operated at a temperature of from 300° C. to 800° C., preferably each zone of the rotary kiln is operated at a temperature of from 310° C. to 720° C., for example from 400° C. to 670° C. In preferred embodiments, the polymer feed experiences increasing temperature as it passes from zone to zone through the kiln. For example, in preferred embodiments the four or more sequential heating zones comprise sequential zones operated at from 310° C. to 600° C. in a first zone to 480° C. to 710° C. in a final zone. Preferably, the final zone of the plurality of zones is heated to a higher temperature then the other heating zones. Heating to a higher temperature in the final zone has been found to reduce loss of hydrocarbon products with the char, as well as increasing processability of the char, without requiring high temperatures that might cause overcracking of the polymer feed to be maintained throughout the kiln. In some embodiments, the heating zones may comprise at least six sequential heating zones. The heating zones suitably comprise separate discrete heating zones, such that each zone is heated at a predetermined temperature, with each subsequent zone being heated at a higher temperature. The flow of material (i.e. polymer feed and intermediate pyrolysis products) through the kiln may be substantially constant along its length. Thus, by varying the length of each heating zone within the kiln, the residence time in each heating zone may suitably be varied. In some preferred embodiments, each heating zone is of equal length, providing equal residence time within each zone, although this is not essential.

The temperature of the zones as referred to herein will be understood to refer to the temperature of the walls of the rotary kiln in each zone, and it will be appreciated that the exact temperature of polymers or pyrolyzed material inside the reactor may vary.

By providing a pyrolysis process using a rotary kiln as described, it has been found that an increased proportion of light waxes having a melting point less than 100° C. may be produced that is readily separable from a lighter sub-C₂₀ liquid fraction, which can itself be used to provide valuable product streams. In particular, it has been surprisingly found that the wax fraction produced in the present process can be separated in a single step from the sub-C₂₀ liquid fraction, and the resulting wax fraction can be separated into various light wax fractions having melting points less than 100° C., preferably no more than 85° C., without the need to expend energy in further fractionation to remove heavier wax fractions. The wax fraction can be produced as approximately 40 wt. % (suitably 20 to 50 wt. %, such as 35 to 45 wt. %) of the C₅₊ liquid fraction of the fluid product stream from the pyrolysis. Thus, the liquid hydrocarbon product stream from the kiln can comprise a C₂₀₊ wax fraction having a melting point of less than 100° C., and a light fraction comprising C₅ to C₂₀ hydrocarbons. The wax fraction can advantageously be further separated to provide three separate wax fractions having respective congealing points in the range of 30-40° C., 50-60° C. and 70-80° C. (30/40 grade, 50/60 grade and 70/80 grade waxes), while the C₅ to C₂₀ fraction may be processed to produce naphtha and diesel. The use of the rotary kiln advantageously provides the production of these hydrocarbon products in a continuous manner where polymer feed is continuously fed to the inlet of the kiln and products are continuously withdrawn from an outlet.

The pyrolysis vessel may be operated at atmospheric pressure (1 atm), for example approximately 101 kPa. Preferably, the rotary kiln is maintained at a slight negative pressure, such as less than 50 kPa below atmospheric pressure, preferably less than 10 kPa below atmospheric pressure, more preferably less than 0.1 kPa below atmospheric pressure, most preferably less than 0.01 kPa below atmospheric pressure, for example from 90 kPa to 101 kPa or preferably from 95 kPa to 101 kPa. Thus, the rotary kiln is preferably operated at approximately atmospheric pressure or at a slight negative pressure of 0.9 bar absolute or higher, for example 0.95 bar absolute or higher. As will be appreciated, the pressure in the rotary kiln may be controlled by controlling and balancing flow, particularly gas flow into and out from the reactor. In particular, a slight negative pressure in the kiln may only be a result of drawing products through a condensation system from the outlet of the kiln.

Residence time within the reactor may be varied by controlling the flow rate of the polymer feed into the kiln and the flow of products out from the kiln, as well as the configuration of the kiln itself. For example, the physical orientation of the kiln (i.e. the extent to which the kiln is inclined from the horizontal) and/or the rate of rotation of the kiln may be varied in order to provide a desired flow of the feed and intermediate pyrolysis products through the kiln. The use of the rotary kiln having multiple heating zones in the present process allows advantageous control over residence time of the polymer feed and intermediate pyrolysis products in the kiln, and within each heating zone. This can allow the process to be easily adapted to vary the product composition, for example to vary the process in response to a change in the polymer feed to maintain a constant product composition, or to vary the process to change the distribution of different products (e.g. the amounts of different hydrocarbon fractions) to meet demand. As will be appreciated, the residence time may be varied depending on the operating conditions inside the kiln. Preferably, the residence time in the kiln is from 30 minutes to 120 minutes, more preferably from 40 minutes to 70 minutes. As discussed previously, the kiln may comprise a final zone heated to a higher temperature than the preceding zones. Thus, the residence time of the feed inside the kiln may be from 30 to 60 minutes, for example from 40 to 50 minutes, at a temperature of from 310° C. to 600° C. and from 5 to 30 minutes, for example from 10 to 20 minutes, at a temperature of from 480° C. to 710° C. in the final zone. it will be appreciated that residence time refers to the time that the molten feed present in the kiln takes to pass from the inlet to the outlet, while pyrolysis vapours formed during the process may pass out from the kiln in the gas phase more quickly than this. A flow of inert gas, preferably nitrogen, is provided at the inlet of the kiln to provide an inert atmosphere and to provide a gas flow to carry pyrolysis vapours to the outlet of the kiln.

Heating of the rotary kiln may be by any suitable means, preferably the rotary kiln is an indirectly heated rotary kiln comprising one or more heaters in which the walls of the kiln are heated from the outside to provide heating to the material within the kiln. For example, the kiln may comprise a rotary kiln enclosed in a furnace or having any suitable heater configured to heat the walls of the kiln. As will be appreciated, the one or more heaters may be separate and arranged to provide heating to each heating zone of the kiln separately, or the one or more heaters may be combined. For example, the heater may comprise a furnace having multiple burners at different points along the length of the kiln, where each burner may be controlled to provide a different heat output (e.g. by controlling fuel flow to the burner), and in some instances the furnace may comprise a common volume surrounding the kiln and a common exhaust outlet for the combustion gases from all burners. Nonetheless, it will be appreciated that any suitable heaters may be provided to provide heating to the heating zones of the kiln.

The process may suitably comprise cooling and condensing the pyrolysis products following the heating zones. For example, the kiln may comprise one or more condensers at or connected to a vapour outlet of the kiln. For example, the kiln may comprise a vapour outlet for providing gases including pyrolysis vapours to the one or more condensers, and a char outlet for receiving the slid char from the kiln. The means for cooling and condensing the pyrolysis products may comprise any suitable condenser or condenser system. Preferably, one or more condensers may be provided with a gaseous fluid product stream of pyrolysis products from the vapour outlet of the kiln. It will be appreciated that the fluid product stream may be a vapour stream that may comprise liquids or solids (such as fine char particles) as aerosols, where the condenser is configured to provide a liquid fraction, along with non-condensable gases. The one or more condensers may for example comprise a quench tower configured to condense the liquid fraction comprising C₅₊ hydrocarbons, and optionally one or more additional condensation stages configured to condense any remaining C₅₊ hydrocarbons in the gaseous effluent from the quench tower and optionally to condense and separate an LPG fraction from the gases.

Thus, a condensation system for condensing vapours from the kiln may comprise a first condensation stage, which may comprise a quench tower, that may suitably be operated at about 50 to 70° C. and a second condensation stage, which may comprise for example one or more tube and shell condensers or the like, operated at about 10 to 30° C. The non-condensable gases, may in some embodiments be used to provide fuel for heating the kiln.

### Pyrolysis Products

The pyrolysis produces a fluid product stream and a solid char product in the kiln, preferably the pyrolysis products from the kiln consist essentially of the fluid product stream and char. The fluid product stream typically comprises a range of hydrocarbons of varying chain length, including a liquid fraction comprising C₅₊ hydrocarbons and non-condensable gas fraction. The fluid product stream preferably consists essentially of a non-condensable gas fraction and a liquid fraction comprising C₅₊ hydrocarbons, wherein the non-condensable gas fraction is separated from the liquid fraction prior to hydrogenation step (v). For example, the non-condensable gases may suitably be drawn from the fluid product stream during condensation, where the fluid product stream is condensed to provide the liquid fraction and the non-condensable gases can be drawn off. As will be appreciated, the composition of the liquid fraction may depend on the process conditions and how the non-condensable gases are separated. For example, in some instances, the liquid fraction may comprise a small proportion of lighter hydrocarbons such as C₄ hydrocarbons, though preferably less than 1 wt. %, for example less than 0.5 wt. % or less than 0.1 wt. %. Preferably, the non-condensable gases make up less than 30 wt. % of the fluid product stream, more preferably less than 25 wt. %, for example less than 20 wt. %. Preferably, the liquid fraction comprising C₅₊ hydrocarbons makes up at least 60 wt. % of the total effluent from the kiln (the total effluent including the liquid fraction, the non-condensable gases and the char), preferably at least 65 wt. %, more preferably at least 70 wt. %, such as at least 75 wt. %, for example about 80 wt. %.

The non-condensable gas may typically comprise C₁ to C₄ hydrocarbon gas which in some preferred embodiments is recycled to provide heating to the kiln and/or to provide heating to melt the polymer feed. In some embodiments, C₃ and C₄ hydrocarbon gas from the non-condensable gases and C₄ gas recovered from the liquid fraction may be separated and provided as an LPG product stream. If present, any C₅₊ hydrocarbons present in the non-condensable gases from the condensation may be recovered and combined with the liquid fraction or downstream products thereof (for example with a naphtha fraction).

The solid char product preferably comprises no more than 15 wt. % of the effluent from the kiln, preferably no more than 10 wt. %. The solid char product in some embodiments can comprise from 10 to 60 wt. % of carbon, for example from 20 to 40 wt. % of carbon, and it will be appreciated that this refers to the carbon content of the char itself, the remainder comprising various non-pyrolysable material present in the polymer feed such as inorganic material and metals.

The process suitably comprises separating the solid char product from the fluid product stream. Such separation may be carried out in any suitable way known for separating solids from a fluid stream. The majority of the char is obtained from the rotary kiln as a solid product stream and is therefore separated from the pyrolysis vapours by providing the char from a char outlet from the kiln separate to the vapour outlet. Nonetheless, some char may be present as an aerosol in the vapours from the kiln that are condensed. Such residual char in the liquid products may be removed in any suitable way. Preferably, the condensed fluid product stream is separated from the residual solid char using a decanter centrifuge or a tricanter centrifuge. For example, liquids from the condenser, for example the quench tower, may be combined with water and separated in a tricanter centrifuge that separates the solid char from the pyrolysis oil liquid fraction and from the water. The liquid fraction may in some embodiments be filtered to remove any residual solids prior to passing to the hydrogenation step.

As the rotary kiln can continuously withdraw char from the reactor (for example in comparison to stirred tank reactors and the like), the process can be operated continuously without the need to stop the process to remove solid residues such as char or other non-volatile residues from the reactor. This also permits the process to be continuously run in a way that provides a desired range of hydrocarbon products, without needing to eliminate char production to avoid downtime and cleaning (which would be necessary in tank reactors at the like).

The liquid fraction comprising C₅₊ hydrocarbons from the kiln may for example have a congealing point in the range of from 40° C. to 60° C. for example from 45° C. to 55° C. (such as 60° C. or less, or 55° C. or less), and/or may have a density of from 0.6 g/ml to 0.9 g/ml, for example from 0.7 g/ml to 0.8 g/ml. Depending on the polymer feed to the kiln, the liquid hydrocarbon fraction may suitably contain sulfur at a concentration of less than 30 mg/kg (as measured by ASTM D5453-19a) but the sulfur concentration may in some instances be at least mg/kg or at least 10 mg/kg. Depending on the feed composition and any steps taken to remove chlorine (e.g. in PVC) from the feed, the liquid hydrocarbon fraction may contain chlorine at a concentration of less than 100 mg/kg (as measured by UOP 779-08), preferably less than 80 mg/kg, but the chlorine concentration may in some instances be at least 10 mg/kg or at least 40 mg/kg, for example at least 60 mg/kg. It will be appreciated that such impurities may in some instances be reduced by treating or controlling the composition of the polymer feed prior to the pyrolysis. The liquid hydrocarbon fraction from the kiln may for example have a bromine index of from 10 to 50 gBr/100 g, preferably 10 to 30 gBr/100 g, for example 15 to 25 gBr/100 g.

### Hydrogenation

The liquid fraction of the fluid product stream comprising C₅₊ hydrocarbons from the kiln is hydrogenated to provide a hydrogenated product stream. Suitably, the entire liquid fraction of the fluid product stream comprising C₅₊ hydrocarbons (i.e. all of the pyrolysis products apart from the char and the non-condensable gases) is passed to a hydrogenation reactor and hydrogenated to produce a hydrogenated hydrocarbon product stream.

Hydrocarbon streams, including those derived by pyrolysis of plastics can typically contain as impurities various heteroatoms such as N, S, O which can negatively affect the properties of the hydrocarbon product. Pyrolysis of polyolefin plastics also typically produces a mixture of olefins and saturated hydrocarbons. Olefins and heteroatom-containing hydrocarbons are more chemically reactive than paraffins. By performing hydrogenation of the entire liquid fraction of the fluid product stream from the kiln prior to further fractionation or processing steps, side reactions of olefins or heteroatom-containing hydrocarbons such as polymerisation may advantageously be avoided. In addition, as olefins and heteroatom-containing hydrocarbon molecules vary in boiling point in comparison to saturated hydrocarbons, the presence of heteroatom-containing molecules and olefins may allow cleaner subsequent separation according to carbon number.

The hydrogenation may be performed in any suitable way and suitably comprises passing the liquid fraction of the fluid product stream in contact with a hydrogenation catalyst and hydrogen gas at a temperature of from 250° C. to 400° C., preferably from 250° C. to 350° C. it will be appreciated that due to the exothermic hydrogenation reaction, the temperature may suitably increase from the inlet to the hydrogenation reactor to the outlet. Thus, the catalyst bed in the hydrogenation reactor may vary in temperature from 250° C. to 400° C., preferably from 250° C. to 350° C. The pressure in the hydrogenation reactor may suitably be from 3 MPa to 10 MPa, preferably from 4 MPa to 6 MPa (in some instances the pressure may be higher such as up to 20 MPa). The liquid hourly space velocity (LHSV) of the fluid product stream through the reactor may be from 0.5 kg/kg/hr to 10 kg/kg/hr, preferably from 0.5 kg/kg/hr to 4 kg/kg/hr, more preferably from 0.7 kg/kg/hr to 2.5 kg/kg/hr, most preferably from 0.8 kg/kg/hr to 1.5 kg/kg/hr, for example from 0.9 kg/kg/hr to 1.3 kg/kg/hr. The ratio of hydrogen gas to feed liquid in the hydrogenation may suitably be from 300 NV/NV to 1000 NV/NV, preferably from 400 NV/NV to 600 NV/NV, for example from 450 NV/NV to 550 NV/NV. The hydrogen consumption during the hydrogenation step will vary based on the feed to the hydrogenation reactor and the other conditions, but may for example be in the range of 6 to 12 gH₂/kg, such as from 8 to 10 gH₂/kg.

The hydrogenation may be performed in any suitable reactor for contacting the liquid fraction with hydrogen gas. Preferably the hydrogenation reactor comprises a fixed bed reactor. The aspect ratio of the fixed bed reactor may be any suitable ratio, and may for example be from 5:1 to 20:1, preferably from 8:1 to 16:1, for example from 10:1 to 14:1 such as about 12:1. The hydrogenation reactor is preferably a trickle bed reactor. In some embodiments, the hydrogenation reactor may alternatively be a fluid bed reactor or a microchannel reactor.

The hydrogenation catalyst may be any suitable catalyst and is preferably a metal catalyst. The metal hydrogenation catalyst preferably comprises a metal selected from Group VIII of the periodic table, preferably the catalyst comprises Fe, Co, Ni, Ru, Rh, Pd, Os, Ir, and/or Pt, such as a catalyst comprising Ni, Co, Mo, W, Cu, Pd, Ru, Pt. In preferred embodiments, the catalyst is selected from CoMo, NiMo or Ni, preferably NiMo. The hydrogenation catalyst is preferably supported on a carrier such as bauxite, alumina, silica, silica-alumina or zeolite. Preferably the catalyst is supported on alumina. For example, the hydrogenation catalyst may comprise NiMo supported on alumina (NiMo/Al₂O₃).

The hydrogenation reactor may comprise a gas recirculation loop to recycle hydrogen through the reactor. The hydrogenation suitably includes hydrodesulphurisation, and the gas phase H₂S concentration in the reactor may be from 0.05% to 0.5% such as about 0.1%. In some embodiments, H₂S may be introduced into the recirculation gas by skimming through CS₂ liquid at ambient temperature and reaction pressure.

In some preferred embodiments, the hydrogenation comprises providing the effluent of the hydrogenation to a second hydrogenation stage, which may be performed under substantially the same conditions as the initial hydrogenation step. The second hydrogenation step may in some instances be performed at a higher initial temperature than the initial hydrogenation step, however due to less of an exotherm the temperature may nonetheless still be in the range of from 250° C. to 350° C., preferably from 300° C. to 350° C. The second hydrogenation step may be performed with a longer contact time than the initial hydrogenation step, for example at a liquid space velocity less than the initial hydrogenation step. It has been found that the second hydrogenation step, while having a minimal effect on heteroatom removal, can advantageously reduce the presence of olefins in the hydrogenated product stream. In some embodiments, the initial and second hydrogenation steps may comprise a combined hydrogenation step equivalent to running the initial and second hydrogenation steps in series. For example, a single hydrogenation step where the contact time through the catalyst bed is increased by lengthening the catalyst bed or lowering the flow rate of the feed through the reactor, or preferably a single hydrogenation step may use a hydrogenation reactor comprising two catalyst beds comprising different catalysts having different activities. In such a hydrogenation step the hydrogen consumption during the hydrogenation step may for example be at least 9 gH₂/kg.

Following the hydrogenation step, the hydrogenated hydrocarbon product stream may for example have a congealing point in the range of from 40° C. to 60° C. for example from 50° C. to 60° C., for example 60° C. or less. Congealing point as referred to herein can be measured according to ASTM D938-12 (2017). The hydrogenated hydrocarbon product stream may have a density of from 0.7 g/ml to 0.9 g/ml, for example from 0.75 g/ml to 0.85 g/ml. Depending on the hydrogenation conditions and the sulfur content of the feed to the hydrogenation, the hydrogenated hydrocarbon product stream may contain sulfur at a concentration of less than 15 mg/kg (as measured by ASTM D5453-19a), preferably less than 10 mg/kg, more preferably less than 5 mg/kg, such as less than 2 mg/kg. Depending on the hydrogenation conditions and the chlorine content of the feed to the hydrogenation, the hydrogenated hydrocarbon product stream may contain chlorine at a concentration of less than 15 mg/kg (as measured by UOP 779-08), preferably less than 10 mg/kg, for example less than 5 mg/kg or less than 2 mg/kg. The hydrogenated hydrocarbon product stream preferably has a bromine index of less than 2 gBr/100 g, preferably less than 1 gBr/100 g, for example less than 0.7 gBr/100 g such as 0.5 gBr/100 g or less. As will be appreciated, the conditions of the hydrogenation may be selected so as to provide the above stated bromine index and/or levels of sulfur and/or chlorine. Thus, where necessary, the hydrogenation conditions may be adjusted to increase contact time, increase the ratio of hydrogen gas to feed liquid, or to use a more active catalyst.

### Fractionation of Hydrogenated Hydrocarbon Product Stream

The present process comprises fractionating the hydrogenated hydrocarbon product stream to produce a C₂₀₊ wax fraction having a melting point of less than 100° C., preferably no more than 85° C., more preferably no more than 75° C. (melting point of waxes as referred to herein can be measured according to ASTM D127-19). Alternatively or additionally, the C₂₀₊ wax fraction may have a congealing point of less than 100° C., preferably no more than 85° C., more preferably no more than 75° C. It will also be appreciated that the C₂₀₊ wax fraction may in some instances contain small amounts of lighter hydrocarbons down to around C₁₈. However, the C₂₀₊ wax fraction preferably contains no more than 15 wt. %, for example no more than 10 wt. %, preferably no more than 5 wt. % of sub-C₂₀ hydrocarbons or products boiling below 350° C. In some embodiments, the C₂₀₊ wax fraction may contain less than 2 wt. %, preferably less than 1 wt. % of products boiling below 350° C., for example where the C₂₀₊ wax fraction preferably consists essentially of C₂₀₊ hydrocarbons. Preferably, the C₂₀₊ wax fraction having a melting point of less than 100° C. makes up from 30 to 50 wt. % of the hydrogenated hydrocarbon product stream, preferably from 35 to 45 wt. %. Thus, while the present process may be operated to produce a C₂₀₊ wax fraction as less than half of the liquid products from the kiln, this can advantageously provide a wax fraction that can be conveniently separated to provide light waxes without the need to separate heavier wax fractions, which will energy intensive. The remaining C₅₋₂₀ liquid fraction of the hydrogenated hydrocarbon product stream may also conveniently be processed to provide diesel and naphtha.

Thus, while it is desired to produce a C₂₀₊ wax fraction in the present process, it has been surprisingly found that increased efficiency for light C₂₀₊ waxes can be achieved by producing and hydrogenating a C₅₊ fraction of the fluid product stream containing a major portion of sub-C₂₀ hydrocarbons and less waxes overall than may typically be produced in wax production processes. The hydrogenated hydrocarbon product stream is then fractionated to provide a C₂₀₊ wax fraction and a C₅₋₂₀ liquid hydrocarbon fraction. As discussed previously, due to boiling point differences of olefins and heteroatom-containing species compared to paraffins, performing the fractionation step after the hydrogenation may aid in avoiding loss of some of the C₂₀₊ waxes into the light fraction (or contamination of the C₂₀₊ wax fraction with sub-C₂₀ hydrocarbons). Without wishing to be bound by any particular theory, the present process comprising controlled pyrolysis in a rotary kiln followed by hydrogenation of the effluent from the kiln, is believed to produce an advantageous distribution of hydrocarbons that permits light waxes to be obtained without requiring fractionation from heavier wax fractions, saving energy and decreasing loss of yield by minimising the number of fractionations required.

The fractionation may be performed using any suitable fractionation means, for example a fractionation column or by a fractional condensation. Preferably, fractionating the hydrogenated hydrocarbon product stream comprises fractionating in a fractional distillation column.

The fractionation may preferably comprise providing the hydrogenated hydrocarbon product stream to a vacuum distillation system. The fractionation may comprise using a reboiler configured to improve liquid evaporation, for example equipped with a jet spray evaporation device and forced flow mechanism configured to improve efficiency of liquid evaporation as well as heat exchanging in the reboiler.

The evaporation temperature of the liquid in the fractionation (for example liquid from a reboiler) may be from 260° C. to 320° C., preferably from 270° C. to 300° C., for example from 280° C. to 290° C. It has been found that minimal degradation of the hydrogenated hydrocarbon product stream can be achieved under such conditions. The evaporation power may for example be from 0.5 kW to 2 KW, for example from 0.9 kW to 1.3 kW. The evaporation pressure may be from 3 to 8 kPa absolute (for example the pressure above the liquid in a reboiler), preferably from 4 to 6 kPa absolute. Condensation of the evaporated products may be performed by cooling to less than around 25° C., for example about 20° C. The hydrogenated hydrocarbon product stream may for example be fed to the fractionation at a temperature of from 60° C. to 300° C., for example from 70° C. to 200° C., for example from 80° C. to 120° C., such as around 100° C. The reflux rate in the fractionation may for example be from 0.5 l/hr to 2 l/hr, for example from 0.8 l/hr to 1.2 l/hr. The vacuum system may suitably comprise a cold trap for preventing loss of light components, for example a cold trap at around −78° C. or less.

### Wax Processing and Separation

The C₂₀₊ wax fraction following the fractionation may suitably have a congealing point of from 60 to 70° C. (as measured by ASTM D938-12 (2017)). Suitably, the C₂₀₊ wax fraction may have a sulfur content of less than 15 mg/kg, preferably less than 10 mg/kg (as measured by ASTM D5453-19a). The bromine index of the C₂₀₊ wax is preferably less than 1 gBr/100 g, more preferably less than 0.5 gBr/100 g.

In some embodiments, the C₂₀₊ wax fraction is decoloured. For example, the C₂₀₊ wax fraction may be decoloured by hydrodecolorisation using hydrogen gas in a fixed bed reactor. The conditions applied may for example be substantially as set out previously herein in relation to the hydrogenation of the C₅₊ liquid fraction of the pyrolysis products, using a temperature of 300 to 350° C. and using a NiWMo/Al₂O₃ catalyst. However, it will be appreciated that any suitable decolourisation method may be used. The decolouration if performed should suitably be performed such that the congealing point (and/or density) of the material remains substantially unchanged so as to have minimal effect on the wax composition.

Suitably, the process comprises fractionating the C₂₀₊ wax fraction to produce two or more separate wax fractions each having a melting point (and/or a congealing point) of less than 100° C., preferably no more than 85° C., for example no more than 80° C. As discussed previously, by use of the present process it has been found that the C₂₀₊ wax fraction from the pyrolysis and hydrogenation may be fractionated into different light wax fractions without the need to separate from heavier waxes (e.g. having a melting point and/or a congealing point of 100° C. or more, preferably 85° C. or more, more preferably 80° C. or more).

Preferably, the C₂₀₊ wax fraction is fractionated to provide at least two, and preferably three, separate wax fractions having respective congealing points in the range of 30-40° C., 50-60° C. and/or 70-80° C.

It will be appreciated that the fractionation in step (vii) of the process may be performed in any suitable way. Preferably, the means for fractionating the C₂₀₊ wax fraction comprises one or more wiped film evaporators, which in preferred embodiments are configured to provide three separate wax fractions having respective congealing points in the range of 30-40° C., 50-60° C. and 70-80° C.

The separate wax fractions may be formed by sequential fractionation steps, for example with fractionators arranged in series. By way of example, where the C₂₀₊ wax fraction is fractionated to provide three separate wax fractions, a first fractionation may be configured to provide a first wax fraction as the light product and to pass the heavy product to a second fractionation. The second fractionation may then be configured to provide a second wax fraction as the light product and the third wax fraction as the heavy product. The first fractionation may for example be operated at a temperature of from 140 to 170° C., preferably from 150 to 160° C. and a pressure of from 40 to 75 Pa absolute, preferably from 50 to 65 Pa absolute. The second fractionation may for example be operated at a temperature of from 250 to 300° C., preferably from 260 to 280° C. and a pressure of from 20 to 60 Pa absolute, preferably from 25 to 45 Pa absolute. While this example refers to only three fractions, it will be appreciated that this may also apply to providing more than three fractions as required.

In some instances, a portion of the light fraction from one stage of the fractionation may be passed to the preceding stage to improve separation efficiency. In addition, the heavy fraction recovered from the final fractionation may where necessary be separated from residual solids in the wax such as residual char or other degradation products or contaminants, for example using a centrifuge.

Where the C₂₀₊ wax fraction comprises sub-C₂₀ hydrocarbons and/or components boiling below 350° C., where necessary these may be separated with the first light fraction of the C₂₀₊ wax fraction, which may then be suitably fractionated to remove the sub-C₂₀ hydrocarbons and/or components boiling below 350° C. Nonetheless, it is preferred that sub-C₂₀ hydrocarbons and/or products boiling below 350° C. are substantially separated from the C₂₀₊ wax fraction in the first fractionation of the hydrogenated hydrocarbon product stream.

Following fractionation of the C₂₀₊ wax fraction, one or more fractions may in some embodiments be subject to decolourisation, which may be alternatively or in addition to decolourisation prior to fractionation as described previously. The decolourisation may be performed under substantially the same conditions as described previously, in some instances at a lower temperature than the previously described decolourisation, for example around 260 to 300° C.

One or more fractions of the C₂₀₊ wax may be processed to provide a wax product for example by pelletisation to provide a pelleted wax product.

While the present process relates to producing waxes, it will be appreciated that the C₅₋₂₀ light hydrogenated fraction separated from the hydrogenated hydrocarbon product stream (to produce the C₂₀₊ wax fraction) may also be processed to provide useful products. For example, further processing of the light hydrogenated C₅₋₂₀ fraction may comprise hydrocracking the C₅₋₂₀ fraction to produce a C₅₋₂₀ hydrocarbon product stream enriched in C₅₋₁₀ hydrocarbons. This can provide an efficiently separable mixture of naphtha (C₅₋₁₀) and diesel (C₁₀₋₂₀) components, as the C₅₋₂₀ fraction typically contains too low of a concentration of naphtha range hydrocarbons to make separation of a naphtha fraction efficient. The hydrocracking step may be performed in any suitable way using any suitable hydrocracking reactor known in the art. For example, the hydrocracking may be performed in a fixed bed reactor such as a trickle bed reactor, which may be an isothermal reactor. The hydrocracking catalyst may be any suitable catalyst and is preferably a metal catalyst supported on a carrier, particularly a sulfur based hydrocracking catalyst such as a catalyst comprising Ni, Co, Mo, W, Cu, Pd, Ru, Pt, preferably NiMo or Pt supported on bauxite, alumina, silica, silica-alumina or zeolite, preferably zeolite such as USY or mordenite zeolite. The hydrocracking may comprise contacting the light hydrogenated C₅₋₂₀ fraction with a hydrocracking catalyst at a temperature of from 250° C. to 400° C., preferably from 300 to 350° C. Preferably, the hydrocracking is performed at a pressure of from 3 to 10 MPa, preferably from 4 to 8 MPa, for example from 5 to 7 MPa. The liquid hourly space velocity (LHSV) of the light hydrogenated fraction through the hydrocracking reactor may be from 0.5 hr⁻¹ to 5 hr⁻¹, preferably from 0.5 hr⁻¹ to 3 hr⁻¹, more preferably from 0.7 hr⁻¹ to 2 hr⁻¹, most preferably from 0.8 hr⁻¹ to 1.5 hr⁻¹, for example from 0.9 hr⁻¹ to 1.3 hr⁻¹. The ratio of hydrogen gas to feed liquid in the hydrogenation may suitably be from 100 NV/NV to 500 NV/NV, preferably from 150 NV/NV to 250 NV/NV, for example from 180 NV/NV to 220 NV/NV. The H₂S level in the reactor may be around from 500 to 1500 ppm such as from 800 ppm to 1200 ppm, for example about 1000 ppm. The sulfur level may suitably be maintained using CS₂ mixed with the feed to the hydrocracking reactor. The C₅₋₂₀ hydrocarbon product stream from the hydrocracking step may be fractionated to produce a naphtha fraction and a diesel fraction (and may optionally be treated with a water wash and/or a H₂S adsorber prior to fractionation). The naphtha fraction suitably comprises C₅₋₁₀ hydrocarbons and preferably comprises at least 90 wt. % C₅₋₁₀ hydrocarbons, preferably at least 95 wt. % C₅₋₁₀ hydrocarbons, for example at least 98 wt. % C₅₋₁₀ hydrocarbons. The diesel fraction suitably comprises C₁₀₋₂₀ hydrocarbons and preferably comprises at least 90 wt. % C₁₀₋₂₀ hydrocarbons, preferably at least 95 wt. % C₁₀₋₂₀ hydrocarbons, for example at least 98 wt. % C₁₀₋₂₀ hydrocarbons. The fractionation of the C₅₋₂₀ hydrocarbon product stream may be performed using any suitable apparatus such as distillation columns with reboiler as are known in the art.

The process can therefore produce a naphtha fraction and a diesel fraction in addition to the wax products, where the naphtha fraction and a diesel fraction may each be provided for downstream use or further processing into other products. In some embodiments, the process may comprise a process for producing waxes and a naphtha fraction in which the diesel fraction from fractionation of the C₅₋₂₀ hydrocarbon product stream is recirculated and provided to the hydrocracking step with the light hydrogenated C₅₋₂₀ fraction. The diesel fraction separated from the naphtha fraction can thereby be recirculated until completely hydrocracked into naphtha fraction species. In this way, the process may surprisingly be operated to produce waxes and naphtha, with minimal wastage of intermediate diesel fraction hydrocarbons. In fact, by operating the process in this way, the advantageous production of both waxes and a naphtha fraction can surprisingly be provided by operating a pyrolysis process that produces a liquid effluent comprising a major portion (e.g. more than 50 wt. %) of diesel hydrocarbons.

It will be appreciated that where a C_{x-y} fraction is referred to herein, unless otherwise specified or clear from the context, the fraction will comprise at least 70 wt. % of hydrocarbons falling within the stated range, preferably at least 80 wt. %, more preferably at least 90 wt. %, such as at least 95 wt. % for example at least 98 wt. %. In some preferred embodiments, a C_{x-y} hydrocarbon fraction may consist essentially of hydrocarbon molecules of carbon number between x and y.

For reference, unless otherwise specified or it is obvious that a contrary meaning is intended, all percentages referring to concentrations in the present application are percentage by weight (wt %).

As will be appreciated the process of the present invention may be performed using the various apparatus features as described herein, and the apparatus may be configured to perform process steps described herein.

The present invention is further described by way of the following Examples, which are provided for illustrative purposes and are not in any way intended to limit the scope of the invention as claimed, and with reference to the following figures in which:

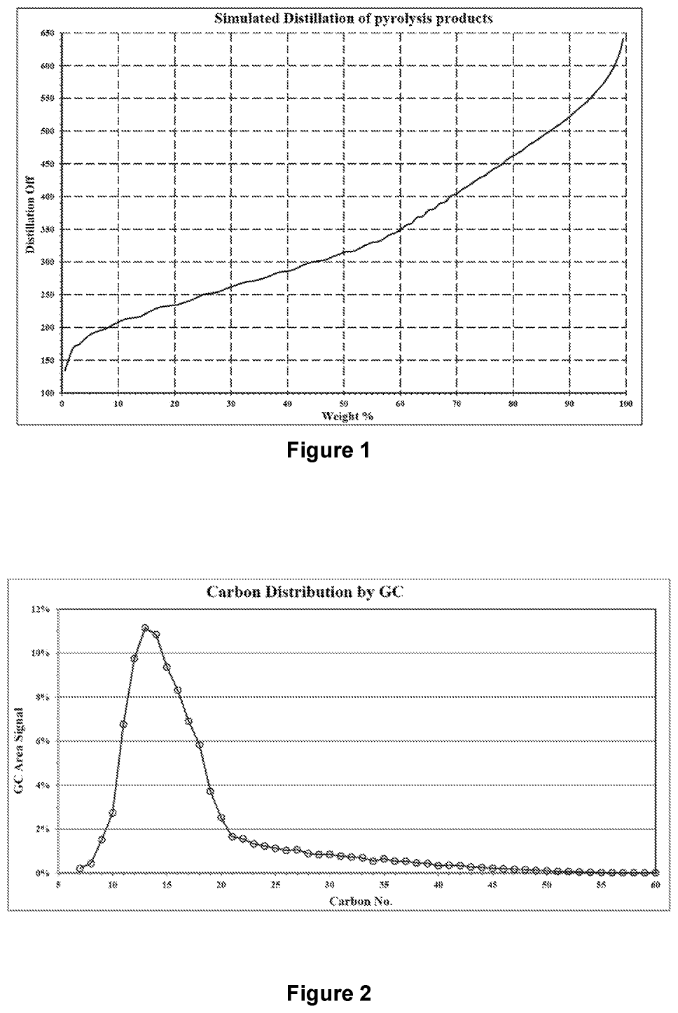

FIG. 1 shows a simulated distillation curve for the liquid product from the pyrolysis of plastics;

FIG. 2 shows carbon number distribution as determined by GC in the liquid product from the pyrolysis of plastics;

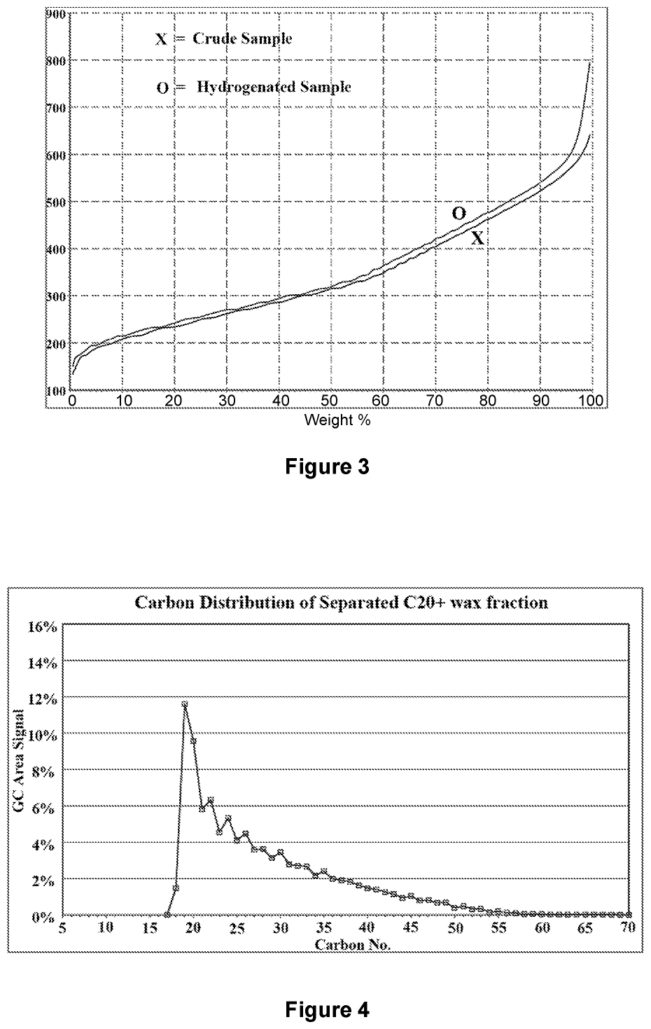

FIG. 3 shows a simulated distillation curve comparing before (X) and after (O) hydrogenation of the liquid product from the pyrolysis of plastics;

FIG. 4 shows carbon number distribution as determined by GC in the separated C₂₀₊ wax fraction of Example 3;

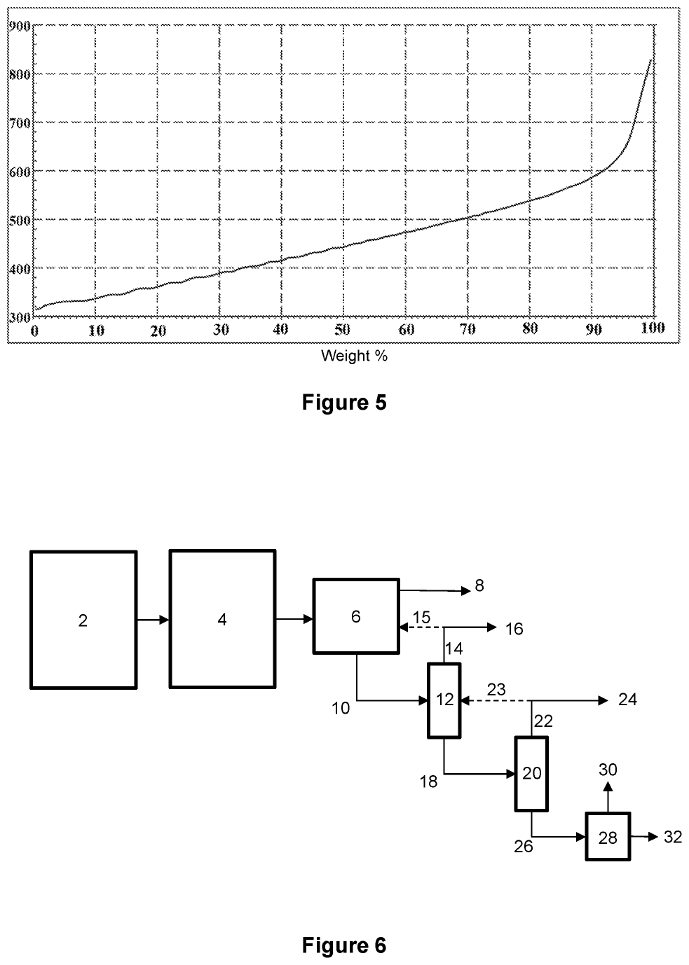

FIG. 5 shows a simulated distillation curve for the separated C₂₀₊ wax fraction of Example 3; and

FIG. 6 shows a schematic process flow for a system configured to perform the present process.

### EXAMPLES

### Example 1—Pyrolysis

A waste plastics feed comprising HDPE, LDPE and polypropylene was melted in a melt extruder and the molten feed stream provided to an inlet of a rotary kiln. The feed stream comprised calcium oxide to avoid corrosion due to HCl formation from any unremoved PVC in the feed. The melt extruder was a screw extruder and was heated by electrically powered heaters.

The rotary kiln comprised a rotating stainless steel drum having a length of about 80 feet (24.3 m) and an internal diameter of about 6 feet (1.8 m). The drum was rotated at a speed of from 0.1 to 2 rpm and was operated under an atmosphere of nitrogen at a pressure slightly below atmospheric pressure. The rotary kiln was heated in four sequential heating zones of equal length, the first three zones were operated at a temperature from 315° C. to 595° C., and the final heating zone was operated at 480° C. to 705° C. Heating of the kiln was performed by combustion of natural gas and directing combustion gases into an external jacket surrounding the rotating drum, which is divided into compartments to control heating in each heating zone. The residence time in the kiln was 60 minutes, 45 minutes in the first three zones and 15 minutes in the final zone.

The effluent from the rotary kiln comprised char as well as a fluid product stream comprising a C₅₊ hydrocarbon liquid fraction and non-condensable gases (including C₁₋₄ hydrocarbon gases and nitrogen). The fluid product stream was removed from the kiln in the vapour phase via a vapour outlet and passed to a condensation system, while the char was collected from a separate char outlet configured to receive solids from the kiln.

The C₅₊ hydrocarbon liquid fraction of the fluid product stream was separated from the non-condensable gases in the condensation system, with a portion of the non-condensable gases passed to fuel heating of the rotary kiln. The condensation system comprised a quench tower and a tube and two tube and shell condensers arranges in series to receive gases from the quench tower. The fluid product stream is provided to the quench tower above the sump, and then is pulled up through 4 spray headers. Liquid is pumped out of the sump of the quench tower and through cooling heat exchangers (cooled to 60° C.), and then to the spray headers. The quench tower spray headers were configured to spray counter-currently to cool the vapour rising through the tower to condense liquid, that then falls into the sump. The spray also serves to scrub out entrained char and prevents it from moving as an aerosol to the downstream unit operations. A stream of cooled liquid from the quench tower was mixed with water and separated in a tricanter centrifuge to remove entrained char and other solid contaminants before the oil phase is returned to the quench tower or passed downstream to the hydrogenation. Any gas that is not condensed in the quench tower can pass through the tube and shell condensers, the first condenser configured to operate at about 20° C. and to provide a condensate spray to remove entrained char from the first condenser and the pipeline between the quench tower and the condenser. The condensate from the first condenser is provided with the liquids from the quench tower to the hydrogenation. Condensate from the second tube and shell condenser (operated at about 10° C.) can be passed to the hydrogenation with the other liquids or combined with the naphtha fraction downstream. The C₅₊ hydrocarbon liquid fraction can be stored in an intermediate storage tank configured to receive liquids from the condensation system and to pass the liquids to the hydrogenation reactor.

The C₅₊ hydrocarbon liquid fraction condensed from the kiln pyrolysis vapours was found to have the following properties:

| Congealing Point: | 52° | C. |
|---|---|---|
| Density (60° C.): | 0.779 | g/ml |
| Bromine Index: | 20 gBr/100 g | |
| Sulfur (ASTM D5453-19a): | 22 | mg/kg |
| Chlorine (UOP 779-08): | 79 | mg/kg |
| Silicon (ASTM D5185-18): | 6 | mg/kg |
| Metal (ASTM D5185-18): | <1 | mg/kg\| |

Note:
a. Tested metals include Cr, Cu, Pb, Ni, Zn, Mn, Cd, As, Co, Sb.
b. Detection limit of ICP of analyzing party was 1 mg/kg.

Simulated distillation of the C₅₊ hydrocarbon liquid fraction was performed and the results are shown in FIG. 1. Carbon number distribution as determined by gas chromatography (GC) in the C₅₊ hydrocarbon liquid fraction is shown in FIG. 2. As can be seen, the pyrolysis products comprise a significant proportion (around 60 wt. %) of hydrocarbons in the diesel range or lower (boiling point up to about 350° C.). Analysis also showed that the pyrolysis products comprise only a very small proportion of C₅₋₈ hydrocarbons in the naphtha range (less than 2 wt. %). GC analysis of the product showed the presence of various isomers as well as n-paraffins in addition to olefins and small amounts of other hydrocarbon species.

### Example 2—Hydrogenation

The C₅₊ hydrocarbon liquid fraction from Example 1 was passed in its entirety to a fixed bed hydrogenation reactor having a catalyst bed aspect ratio of 12:1 and comprising a NiMo/Al₂O₃ hydrogenation catalyst. The temperature set at the inlet of the reactor was 260 to 270° C. and the pressure was 5.0 MPa. The feed was provided with a LHSV of 1.1 h⁻¹, and a hydrogen gas to feed ratio of 500 NV/NV. A gas phase H₂S concentration was around 0.1% introduced by skimming a portion of recirculation gas through CS₂ liquid at ambient temperature and reaction pressure. The temperature at the outlet of the reactor was around 350° C., giving a temperature rise through the reactor of around 90° C. The hydrogen consumption was about 8.2 gH₂/kg. No noticeable cracking of the feed was observed during the hydrogenation, neither C₃-4 (LPG) or C₁₋₂ gases.

The hydrogenated product was found to have a bromine index of 2 gBr/100 g, and so the hydrogenated product was passed to a second equivalent hydrogenation in which the initial temperature at the inlet of the reactor was 305° C. and the outlet temperature was 330° C., and the LHSV was 0.7 h⁻¹. Product recovery over the two hydrogenation steps was more than 95%.

The twice hydrogenated product was analysed and had the following properties:

| Congealing Point: | 54° | C. |
|---|---|---|
| Density (60° C.): | 0.806 | g/ml |
| Bromine Index: | 0.5 gBr/100 g | |
| Sulfur (ASTM D5453-19a): | 14 | mg/kg |
| Chlorine (UOP 779-08): | 12 | mg/kg |
| Silicon (ASTM D5185-18): | 6 | mg/kg |
| Metal (ASTM D5185\|-18): | <1 | mg/kg |

Note:
Tested metals include Cr, Cu, Pb, Ni, Zn, Mn, Cd, As, Co, Sb, Mo, Al.

The hydrogenated product was also found by GC to be substantially free of the olefins observed prior to hydrogenation.

Simulated distillation of the hydrogenated product was performed and the results in comparison to the crude product prior to hydrogenation are shown in FIG. 3. As can be seen in FIG. 3, the boiling point of the hydrogenated product (labelled O) was increased relative to the crude material before hydrogenation (labelled X). At the 350° C. boiling point range where the C₂₀₊ waxes are separated from the lighter liquid fractions, the hydrogenation can be seen to reduce the proportion of material boiling under 350° C., indicating that by performing the hydrogenation of the entire liquid effluent of the kiln prior to separation, this may allow an increased portion of C₂₀₊ hydrocarbons that otherwise might have been lost in the light fraction, to be retained with the C₂₀₊ wax fraction following fractionation. Particularly in the case of producing light waxes, it is advantageous to avoid loss of light hydrocarbon wax components.

### Example 3—Fractionation

The hydrogenated product was then fractionated with a single cut to provide a light hydrogenated C₅₋₂₀ hydrocarbon fraction and a C₂₀₊ wax fraction. The fractionation was performed in a distillation tower using vacuum distillation. The distillation system included a reboiler equipped with jet spray evaporation device and forced flow mechanism to improve efficiency of liquid evaporation and heat exchange in the reboiler. The distillation was operated under the following conditions:

| Evaporation temperature | ~275° | C. |
|---|---|---|
| (liquid from reboiler): | | |
| Evaporation pressure | 4~6 kPa (absolute) | |
| (above liquid in reboiler): | | |
| Evaporation power: | ~1.1 | kW |
| Cooling water temperature: | ~20° | C. |
| Pressure at condenser outlet: | ~1 | kPaA |
| Sample liquid (~100° C.) | 2~2.5 | kg/hr |
| feed rate: | | |
| Reflux rate: | ~1 | litre/hr |
| Cold trap temperature | −78° | C. |
| (of vacuum pump): | | |

The distillation produced a light hydrogenated C₅₋₂₀ hydrocarbon fraction and a C₂₀₊ wax fraction. The C₂₀₊ wax fraction was found to contain a portion of diesel length hydrocarbons (mostly C₁₈ and C₁₉) and so preferably the temperature of the reboiler may be increased to compensate for this, for example to around 285° C. or higher.

The C₂₀₊ wax fraction was analysed as follows:

| Density (80° C.): | 0.810 | g/ml |
|---|---|---|
| Bromine index: | <0.5 gBr/100 g | |
| Congealing point: | 65° | C. |
| Sulfur (ASTM D5453-19a): | 9.2 | mg/kg |

Simulated distillation of the C₂₀₊ wax fraction was performed, and the results are shown in FIG. 5. Carbon number distribution as determined by gas chromatography (GC) in the C₂₀₊ wax fraction is shown in FIG. 4. The C₂₀₊ wax fraction was found to contain an advantageous distribution of hydrocarbons for producing relatively low melting point waxes, particularly three separate wax fractions having respective congealing points in the range of 30-40° C., 50-60° C. and 70-80° C.

The C₂₀₊ wax fraction was decolourised over a fixed bed prior to fractionation, according to the following conditions:

| Catalyst: | NiWMo/Al₂O₃ | |
|---|---|---|
| Aspect ratio of catalyst bed: | 12:1 | |
| Reactor temperature | 320° | C. |
| (set at inlet): | | |
| Reactor temperature | 320° | C. |
| (measured at outlet): | | |
| Reaction pressure: | 5.0 | MPa |
| Liquid space velocity: | 1.0 | kg/kg/hr |
| Hydrogen gas to feed | ~500 | NV/NV |
| liquid ratio: | | |

| | |
|---|---|
| Gas phase H₂S concentration: | ~0.1% |

The density and congealing point of the C₂₀₊ wax fraction was unchanged by the decolourisation.

### Example 4—Fractionation of Waxes

The C₂₀₊ wax fraction from Example 3 (69.5 kg) was separated sequentially via fractionation with a wiped film evaporator.

The first separation (performed at a temperature of 155° C. and a pressure of 55-60 Pa absolute and a feed rate of 2.8 kg/hr) produced a first light fraction that was further fractionated to remove diesel range hydrocarbons and provide a 30/40 wax product having a congealing point of 35° C. As will be appreciated, the diesel range hydrocarbons may preferably instead be removed during the separation of Example 3. The first heavy fraction from the first separation was provided to a second separation (performed at a temperature of 270° C. and a pressure of 30-40 Pa absolute and a feed rate of 2.5-3 kg/hr) to produce a second light fraction having a congealing point of 55° C. (providing a 50/60 wax product) and a second heavy fraction having a congealing point of 77° C. (providing a 70/80 wax product). Analysis of these wax fractions is shown in Table 1.

TABLE 1

| | | 30/40 | 50/60 | 70/80 |
|---|---|---|---|---|
| Item | Unit | Wax | Wax | Wax |
| Quantity | kg | 3.8 | 30.5 | 17.0 |
| Density (20° C.) | g/ml | | 0.888 | 0.916 |
| Congealing Point | ° C. | 35 | 55 | 77 |
| Sulfur* | mg/kg | | <10 | <10 |
| Chlorine | mg/kg | <1 | <1 | <1 |
| Silicon | mg/kg | <1 | <1 | <1 |
| Other Metal | mg/kg | <1 | <1 | <1 |

*Detection limit

FIG. 6 shows schematically a process flow of a system for performing the present process. A polymer feed is pyrolyzed in a rotary kiln reactor 2 and the fluid effluent from the kiln comprising all of the condensable liquids from the pyrolysis is provided to a hydrogenation reactor 4. The hydrogenated hydrocarbon stream from the reactor 4 is passed to a fractionation stage 6 to provide a C₂₀₊ wax fraction 10 and a C₅₋₂₀ hydrocarbon fraction 8 (diesel/naphtha fraction). The C₂₀₊ wax fraction 10 is provided to a first wax fractionation stage 12 (comprising a wiped film evaporator), from which a first light fraction 14 is obtained. The first light fraction 14 is provided as a 30/40 wax stream 16 having a congealing point from 30 to 40° C., and optionally a portion 15 of the first light fraction is recirculated to the fractionation stage 6 to improve removal of diesel/naphtha fraction components. A first heavy fraction 18 from first wax fractionation stage 12 is provided to a second wax fraction stage 20 (comprising a wiped film evaporator), from which a second light fraction 22 is obtained. The second light fraction 22 is provided as a 50/60 wax stream 24 having a congealing point from 50 to 60° C., and optionally a portion 23 of the second light fraction is recirculated to the first wax fractionation stage 12. A second heavy fraction 26 from the second wax fraction stage 20 provides a 70/80 wax stream, optionally with separation of residual solids such as char or other solid contaminants 30 using a solid/liquid separator 28, for example comprising a centrifuge.

1. A process for producing waxes having a melting point of less than 100° C. from a polymer feed, the process comprising:
(i) providing a polymer feed comprising at least 80 wt. % of polyolefin polymers;
(ii) melting the polymer feed to provide a molten polymer feed;
(iii) passing the molten polymer feed to a rotary kiln reactor comprising a plurality of sequential heating zones, wherein each zone of the rotary kiln is operated at a temperature of from 300° C. to 800° C. to pyrolyze the molten polymer feed and produce a fluid product stream and a solid char product;
(iv) separating the solid char product from the fluid product stream;
(v) passing a liquid fraction of the fluid product stream comprising C₅₊ hydrocarbons to a hydrogenation reactor and hydrogenating said liquid fraction to produce a hydrogenated hydrocarbon product stream;
(vi) fractionating the hydrogenated hydrocarbon product stream to produce a C₂₀₊ wax fraction having a melting point of less than 100° C.;
(vii) fractionating the C₂₀₊ wax fraction to produce two or more separate wax fractions each having a melting point of less than 100° C.

2. A process according to claim 1, wherein fractionating the hydrogenated hydrocarbon product stream comprises fractionating in a fractional distillation column.

3. A process according to claim 1 or claim 2, wherein the rotary kiln comprises four or more sequential heating zones.

4. A process according to any one of the preceding claims, wherein the rotary kiln is maintained under an atmosphere of nitrogen.

5. A process according to any one of the preceding claims, wherein the rotary kiln is operated at approximately atmospheric pressure or at a slight negative pressure of 0.9 bar absolute or higher, for example 0.95 bar absolute or higher.

6. A process according to any one of the preceding claims, wherein each zone of the rotary kiln is operated at a temperature of from 310° C. to 720° C., preferably from 400° C. to 650° C.

7. A process according to any one of the preceding claims, wherein the final zone of the plurality of zones is heated to a higher temperature then the other heating zones, preferably wherein the plurality of heating zones comprise sequential zones operated at from 310° C. to 600° C. in one or more zones and from 480° C. to 700° C. in a subsequent final zone.

8. A process according to any one of the preceding claims, wherein the polymer feed comprises at least 85 wt. % polyolefin polymers, preferably at least 90 wt. % polyolefin polymers, more preferably at least 95 wt. % polyolefin polymers, for example at least 99 wt. % polyolefin polymers.

9. A process according to any one of the preceding claims, wherein the polyolefin polymers comprise or consist essentially of polyethylene and polypropylene, for example wherein the polyolefin polymers comprise at least 90 wt. % polyethylene and polypropylene, preferably at least 95 wt. % polyethylene and polypropylene, for example at least 99 wt. % polyethylene and polypropylene.

10. A process according to any one of the preceding claims, wherein the polymer feed is melted in a melt extruder.

11. A process according to claim 10, wherein the melt extruder is heated at a temperature of from 250° C. to 350° C., preferably from 265° C. to 325° C.

12. A process according to any one of the preceding claims, wherein calcium oxide is added to the polymer feed, preferably in an amount of up to 3 wt. %

13. A process according to any one of the preceding claims, wherein at least a portion of a non-condensable gas fraction is recycled to provide heating to the rotary kiln and/or to melt the polymer feed.

14. A process according to any one of the preceding claims, wherein the solid char product comprises no more than 15 wt. % of the effluent from the kiln, preferably no more than 10 wt. %.

15. A process according to any one of the preceding claims, wherein the hydrogenation reactor in step (v) comprises a fixed bed reactor, preferably a trickle bed reactor.

16. A process according to any one of the preceding claims, wherein the solid char product is separated from the fluid product stream at least in part by a decanter centrifuge or a tricanter centrifuge.

17. A process according to any one of the preceding claims, wherein the fluid product stream comprises a non-condensable gas fraction and a liquid fraction comprising C₅₊ hydrocarbons, wherein the non-condensable gas fraction is separated from the liquid fraction prior to step (v).

18. A process according to any one of the preceding claims, wherein the hydrogenation catalyst is a metal catalyst, preferably wherein the metal hydrogenation catalyst comprises a metal selected from Group VIII of the periodic table, preferably the catalyst comprises Fe, Co, Ni, Ru, Rh, Pd, Os, Ir, and/or Pt, such as a catalyst comprising Ni, Co, Mo, W, Cu, Pd, Ru, Pt, and preferably wherein the catalyst is selected from CoMo, NiMo or Ni, more preferably wherein the catalyst is NiMo; and/or wherein the catalyst is supported on a carrier preferably selected from bauxite, alumina, silica, silica-alumina or zeolite, preferably alumina.

19. A process according to any one of the preceding claims, wherein the C₂₀₊ wax fraction is fractionated in step (vii) to provide three separate wax fractions having respective congealing points in the range of 30-40° C., 50-60° C. and 70-80° C.

20. An apparatus for producing waxes having a melting point of less than 100° C. from a polymer feed, the apparatus comprising:
(i) means for melting a polymer feed comprising at least 80 wt. % of polyolefin polymers to provide a molten polymer feed;
(ii) a rotary kiln reactor configured to receive the molten polymer feed from part (i), the rotary kiln reactor configured to provide a plurality of sequential heating zones, wherein each zone of the rotary kiln is configured to be operated at a temperature of from 300° C. to 800° C. to pyrolyze the molten polymer feed and produce a fluid product stream and a solid char product;
(iii) means for separating the solid char product from the fluid product stream; and
(iv) a hydrogenation reactor configured to receive a liquid fraction of the fluid product stream comprising C₅₊ hydrocarbons from part (iii) and to hydrogenate said liquid fraction to produce a hydrogenated hydrocarbon product stream;
(v) means for fractionating the hydrogenated hydrocarbon product stream to produce a C₂₀₊ wax fraction having a melting point of less than 100° C.;
(vi) means for fractionating the C₂₀₊ wax fraction from (v) to produce two or more separate wax fractions each having a melting point of less than 100° C.

21. An apparatus according to claim 20, wherein the means for fractionating the hydrogenated hydrocarbon product stream comprises a fractional distillation column configured for receiving the hydrocarbon product stream from the hydrogenation reactor.

22. An apparatus according to claim 20 or claim 21, wherein the rotary kiln is configured to provide four or more sequential heating zones, preferably wherein the rotary kiln is configured to operate as defined in any one of claims 4 to 7.

23. An apparatus according to any one of claims 20 to 22, wherein the means for melting the polymer feed comprises a melt extruder, preferably configured to heat the polymer feed at a temperature of from 250° C. to 350° C., preferably from 265° C. to 325° C.

24. An apparatus according to any one of claims 20 to 23, wherein the apparatus is configured to recycle a gas fraction of the hydrocarbon product stream to provide heating to the rotary kiln and/or to melt the polymer feed.

25. An apparatus according to any one of claims 20 to 24, wherein the hydrogenation reactor in part (iv) comprises a trickle bed reactor, preferably wherein the catalyst is as defined in claim 18.

26. An apparatus according to any one of claims 20 to 25, wherein the means for separating the solid char product from the fluid product stream comprises a decanter centrifuge or a tricanter centrifuge, and/or wherein the means for separating the solid char product from the fluid product stream comprises a char outlet from the rotary kiln and a vapour outlet from the rotary kiln, separate to the char outlet, for receiving the fluid product stream the rotary kiln.

27. An apparatus according to any one of claims 20 to 26, wherein the means for fractionating the C₂₀₊ wax fraction in part (vi) comprises one or more wiped film evaporators configured to provide three separate wax fractions having respective congealing points in the range of 30-40° C., 50-60° C. and 70-80° C.
